(19) United States
(12) Patent Application Publication
(10) Pub. No.: US 2004/0246703 A1
(43) Pub. Date: Dec. 9, 2004

(54) Height adjustable anchored floating pool lights

(76) Inventor: Cameron W. Adams, Wichita, KS (US)

Correspondence Address: Donald W. Meeker, Patent Agent, 924 East Ocean Front #E, Newport Beach, CA, 92661, US

(21) Appl. No.: 10/455,872

(22) Filed: Jun. 6, 2003

(51) Int. Cl. F21V 9/16

(52) U.S. Cl. 362/84

(57) ABSTRACT

The present invention relates floating pool lights with a preset cord lengths or adjustable length cords, each attached to an anchor device for various depths of the floats in the water above the anchor devices. The floating pool light utilizes a replaceable sealed tube with a chemical source of light inside a spherical air-filled float and does not require any wiring or power source. The floating pool light further comprises a movable reflective decorative anchor using fluorescent glass discs contained in a mesh bag, which can be positioned anywhere in the pool to hold down the device and maintain it in place at a desired depth and location.

### BACKGROUND OF THE INVENTION

1. Field of the Invention

The present invention relates generally to pool lights and in particular to floating pool lights using chemical light sources with a cord attached to a light reflective anchor.

2. Description of the Prior Art

Swimming pools provide substantial relaxation and enjoyment as well as healthful exercise and activity. In addition, swimming pools also provides aesthetic enhancement of their environments. This is particularly true of swimming pools used in residential situations such as single family homes and apartment or condominium complexes. In many instances, homeowner's in the process of landscaping and planning their backyards and patio areas virtually center the decoration and landscaping about the swimming pool. In response to the consumer sensitivity to the aesthetic qualities of swimming pools, practitioners in the pool arts have brought forth various attractive features to enhance the appeal of their respective swimming pool products. These features have included attractive shapes of the pools themselves as well as attractive cooperating patio and sidewalk materials. In addition, practitioners have provided various decorative lights.

Most floating pool decorations and lights tend to float onto the skimmer of the pool due to the flow of water through the skimmer and filter system. This can clog the skimmer and adversely affect the filtering system of the pool.

Another problem with pool lights is providing a source of power to light the lights and maintain the lights, power source and power transmission lines out of contact with the water.

Prior art devices do not adequately address these problems.

U.S. Pat. No. 6,502,953, issued Jan. 7, 2003 to Hajianpour, provides a floating light that includes a lower base section, in which a battery holder is mounted, an electrically-driven light source, and an upper housing including an illuminated portion transmitting light. In one version, the upper housing is a translucent hemisphere, and the lower base portion includes a hemispherical internal reflector. In another version, the upper housing includes flexible transparent tubes in which LEDs are illuminated. In yet another version, upper housing includes optical fibers illuminated by a bulb. A plug filling an outer hole in the lower base section is preferably movable to turn the light on and off and removable to provide for battery replacement.

U.S. Pat. No. 6,220,718, issued Apr. 24, 2001 to Burgess, claims an artificial floating candle that mimics real burning candles. The floating candle comprises two parts, a floating candle-like device and an electrical circuit that controls the amount of power supplied to each floating candle. The floating candle-like device comprises an incandescent lamp, a lamp housing socket, a candle, a candle base, grommets or O-rings, at least two conductor insulated wires, a multi-conductor, a trunk line, a water tight splice, and a candle enclosure. There are three sections that comprise the electrical circuitry of the floating candles: a low voltage supply (AC to DC, high to low voltage conversion), a pulse width modulation programmed micro-controller and a power output section (to control the incandescent lamp voltage to produce flickering flames), and trunk and feeder lines. The floating candles may be used as Christmas lights, at wedding reception halls, amusements parks, or in pools or ponds at evening parties as decoration.

U.S. Pat. No. 5,934,796, issued Aug. 10, 1999 to Quereau, discloses an ornamental lighting apparatus for a pool that uses reflectors on a curved surface, wherein the curved surface is preferably a hemisphere with a plurality of mirrors mounted on its outer surface. The hemisphere is connected to one or more lights that are directed at the mirrors on the hemisphere. Although movement of the lighting apparatus and/or the water in the pool is sufficient to create a varying light pattern on the sides and bottom of the pool, in a preferred embodiment, the mirrored hemisphere is rotated with respect to the lights to create a moving pattern of light on the pool walls and bottom. The lighting apparatus may be positioned such that a base unit is resting on the bottom of the pool with the connector between the light containing base unit and the hemisphere being of adjustable length. Alternatively, the entire lighting apparatus may float within the pool and the connector may be of fixed length. The hemisphere may be formed to be a closed container with a resealable opening and the buoyancy of the apparatus may be adjusted by adding selected amounts of water to the hemisphere. The lighting and the motor for rotation, if used, may be powered by a low-voltage rechargeable battery.

U.S. Pat. No. 5,351,432, issued Oct. 4, 1994 to Tse, illustrates a float with a light apparatus that comprises a floating body, which has a guard shaped configuration. The floating body is comprised of a lower housing and an upper housing. The lower housing has an external threaded portion at its lower end, and the upper housing has a cylindrical projection at its upper end. The upper housing and the lower housing jointly define an apartment therebetween. A battery apartment has a cylindrical configuration. The battery apartment has a inner threaded portion at its upper opening for being screwed onto said lower end of the lower housing. A power supply assembly is installed within the battery. The power supply assembly extending further into the lower housing. A first light indicating source is installed onto the upper end of the upper housing. The first light indicating source constructs an electrical connection with the power supply assembly via suitable electrical wires. A second light indicating source is installed within the apartment defined by said lower housing and upper housing. Said second light indicating source constructs an electrical connection with said power supply assembly via suitable electrical wires. An actuating means, slidably mounted onto said cylindrical projection of the upper housing, moves to a triggering position to switch on said second light indicating source as a fish is hooked.

U.S. Pat. No. 3,748,457, issued Jul. 24, 1973 to Balitzky, is for a battery-operated safety light for a swimming pool. This device is a circular and floatable disc-like structure that has on its interior a plurality of batteries, which are enclosed in a watertight compartment thereof. A bulb extends from a reflector at the lower portion of the device within a waterproof globe, so as to illuminate the water within the pool at night.

U.S. Pat. No. 4,394,716, issued Jul. 19, 1983 to Campagna, claims an underwater light assembly for internal illumination of swimming pools and the like which operates on batteries and does not require any externally-provided current. A partitioned compartment is detachably engaged within and against a transparent dome. The compartment houses weights to keep the assembly submerged in a pool of water. The compartment also houses the batteries and a power assembly for providing current to a lamp socket. The lamp socket is suspended within the compartment. A detachable seal is provided to seal the compartment within and against the transparent dome. A metal contact plate is provided on the detachable seal such that, when the seal is inserted and seals the compartment within and against the transparent dome, an electrical connection is completed and the power assembly supplies current to the lamp socket. The underwater light assembly may be constructed for either incandescent or fluorescent lamps, rests on the bottom of the pool of water and may be adapted for mounting on the sidewall enclosing the pool of water.

U.S. Pat. No. 3,955,076, issued May 4, 1976 to Shaw, describes an underwater swimming pool illumination system that includes a lighting assembly which has a lamp unit installed within its rear portion in a waterproof enclosure; and the lamp is connected to a low voltage battery. The waterproof enclosure may be at the bottom of a strut in an inverted L-shaped assembly, where the upper portion is a base that is fitted to a pad by a bayonet-type connection. The battery may be installed in the base, in which case the lighting assembly may be removed away from the pool to have the battery charged; or the battery may be remotely installed with a wire connection to the pad and lighting assembly. In either case, the installation is such that the lamp is completely electrically isolated from an alternating or ripple currents; either by physically removing the lamp from the pool for battery charging, or by a DPDT switch which either connects the battery to the lamp or to the charging circuit. Thus, in either case the battery is charged in a place remote from the swimming pool. The waterproof lamp enclosure seals the rear portion of a seated beam lamp in a bowl-shaped body by an O-ring seal, when a retaining ring around the lamp is tightened against it. The retaining ring may be of a light diffracting material. The waterproof enclosure may also be attached to the wall of a swimming pool.

U.S. Pat. No. 3,949,213, issued Apr. 6, 1976 to Paitchell, discloses an underwater light that is for use particularly with swimming pools, having fail-safe twin grounding connectors to prevent electrical grounding through the water in event of failure of one grounding connection.

U.S. Pat. No. 2,908,101, issued Oct. 13, 1959 to Butler, indicates an illuminated fishing float that is also usable as a distress signal or a position marker. The device has a light source that is adapted to float in the water, projecting downwardly to attract fish. The light source may be projected upwardly for use as a distress signal. The device has a means for attaching a fishing line or an anchor line, depending on the use of the device.

What is needed is a floating pool light which does not float freely on top of the water to prevent clogging the skimmer and also a floating pool light which does not provide an electricity hazard, as well as a floating pool light which can be positioned at any desired depth in the water.

### SUMMARY OF THE INVENTION

An object of the present invention is to provide a floating pool light that is anchored to the bottom of the pool and does not float freely on top of the water so that it does not clog the skimmer.

Another object of the present invention is to provide a floating pool light which utilizes a sealed replaceable tube with a chemical source of light inside a float so that it does not provide an electricity hazard nor require any wiring or power source.

One more object of the present invention is to provide a floating pool light with variously preset cord lengths or an adjustable length cord attaching it to an anchor at the bottom of the pool so the floating light can be positioned at any desired depth in the water.

An additional object of the present invention is to provide a movable decorative light reflective anchor using fluorescent glass inside a mesh bag, which can be positioned anywhere in the pool to hold down the floating pool light and maintain it in place at a desired depth and location.

In brief, the present invention relates to a floating pool light with a series of preset cords of various lengths or an adjustable length cord attached to an anchor. The anchor cord extends between the float and the anchor device, and is capable of being shortened or lengthened to adjust the depth of the float in the water above the anchor device, thereby keeping the float from clogging the skimmer. The float comprises a lighter-than-water container, which has a self-contained source of light and a means for retaining an anchor cord. The floating pool light utilizes a replaceable sealed tube with a chemical source of light inside the float and does not require any wiring or power source, nor does it present an electrical hazard. The device further comprises a movable decorative reflective anchor using fluorescent glass discs inside a mesh bag, which can be positioned anywhere in the pool to hold down the floating pool light and maintain it in place at a desired depth and location. The floating light may be used to improve safety in and around the pool, by providing an illuminated environment. The device also may be used to provide an aesthetic decorative means.

An advantage of the present invention is that it is anchored and does not clog the skimmer.

Another advantage of the present invention is that it does not provide an electricity hazard.

An additional advantage of the present invention is that it does not require any wiring or power source.

One more advantage of the present invention is that it can be moved to different locations in a pool.

Yet another advantage of the present invention is that the floating light can be positioned at any desired depth in the water.

Still another advantage of the present invention is that it provides a safer, illuminated environment.

A further advantage of the present invention is in providing a decorative means.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 illustrates a cross sectional view of a pool with three floating pool lights installed within the pool.

### BEST MODE FOR CARRYING OUT THE INVENTION

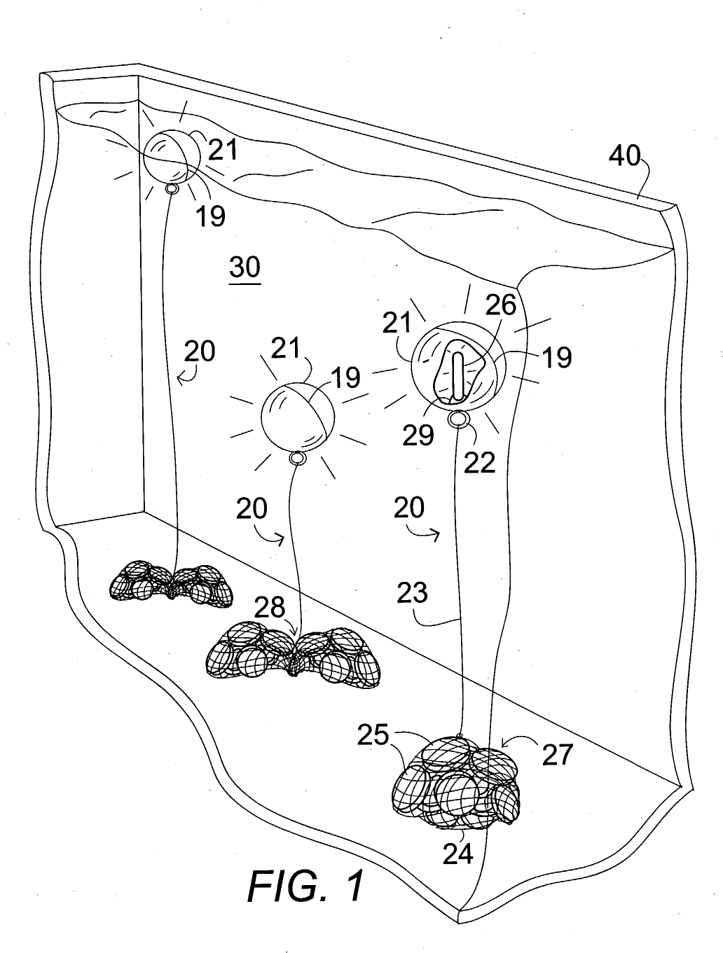

In FIG. 1, a floating light 20 is shown, which comprises a float 21 which is a lighter-than-water container. The container has a self-contained source of light, such as a replaceable chemical light tube 26 friction fit removably into a holder 29 with an opening to receive the tube inside the float 21, and a bottom attachment means, such as a bottom external loop 22, for retaining an anchor cord 23. The float 21 preferably comprises an air-filled spherical container with a watertight seam 19 that may be opened at the seam to split the spherical container along the seam to replace the chemical light source, such as the chemical light tube 26, removably fixed within the container. The external surface of the float 21 is light transmissive (translucent or transparent) for at least a portion and preferably all of the surface of the container to let the light out and can also be luminescent.

The floating light 20 also includes an anchor device 27 that comprises at least one heavier-than-water element 25 and a top attachment means for retaining an anchor cord 23. The anchor device 27 preferably comprises a mesh bag 24 filled with luminescent elements 25, which may be luminescent glass discs 25 for a light reflective decorative anchor. The anchor means for retaining the anchor cord 23 may comprise a loop at the top of the mesh bag or an indented center portion 28 of the mesh bag 24 for receiving the anchor cord 23 to be wrapped around as desired to adjust the length of the cord for varying the depth of the float.

In practice, the floating light 20 could be used in most bodies of water 30, but would be very advantageous for use in a pool 40, as shown in FIG. 1.

The floating lights 20 are preferably provided in packages containing several of the lights with cords 23 of various lengths so that the user merely lowers the anchor devices 27 into the pool in various locations. The user may also adjust the length of a cord by winding the anchor cord 23 around an indented center portion 28 of the mesh bag 24, leaving a desired length of the cord 23 free.

The floating light 20 may be used to improve safety and add to the visual interest in and around the pool 40, by providing an illuminated environment. The device 20 also may be used to provide an aesthetic decorative means, and may be moved to different locations in the pool 40.

It is understood that the preceding description is given merely by way of illustration and not in limitation of the invention and that various modifications may be made thereto without departing from the spirit of the invention as claimed.

1. A floating light device comprising:
a float comprising a lighter-than-water container with at least one light transmissive exterior surface communicating between an interior and an exterior of the container, a water-tight opening means for accessing the interior of the container, a light source retaining means for removably receiving and retaining a light source in the interior of the container, and a bottom attaching means for retaining an anchor cord;
a replaceable light source comprising a tubular element housing a chemical light source, the tubular element capable of being removably installed in the light source retaining means;
an anchor device comprising at least one heavier-than-water element and a top attaching means for retaining an anchor cord, wherein the anchor device comprises a mesh bag filled with luminescent elements;
an anchor cord extending between the float and the anchor device, the cord adapted for determining the depth of the float in the water above the anchor device.

2. The floating light device of claim 1 wherein the light source retaining means comprises an interior portion of the container having an opening adapted for removably receiving the tubular element therein with a tight friction fit.

3. The floating light device of claim 1 wherein the anchor device comprises a light reflective heavier than water device.

4 (canceled).

5. The floating light device of claim 1 wherein the luminescent elements are luminescent glass discs.

6. The floating light device of claim 1 wherein the anchor means for retaining the anchor cord comprises an indented center portion of the mesh bag for receiving the anchor cord wound around the center portion to vary the length of the anchor cord.

7. The floating light device of claim 1 wherein an external surface of the float is translucent.

8. The floating light device of claim 1 wherein an external surface of the float is luminescent.

9. The floating light device of claim 1 wherein the float comprises a spherical container adapted for reversibly separating in half along a waterproof seam which comprises the water-tight opening means for accessing the interior of the container.

10. The floating light device of claim 1 wherein the bottom attaching means for retaining the anchor cord comprises an external loop on a bottom of the container.
